(19) United States
(12) Patent Application Publication
(10) Pub. No.: US 2007/0216218 A1
(43) Pub. Date: Sep. 20, 2007

(54) Brake by wire type brake system

(75) Inventors: Satoshi Matsushita, Saitama (JP); Kunimichi Hatano, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/703,592

(22) Filed: Feb. 7, 2007

(30) Foreign Application Priority Data
Mar. 14, 2006 (JP) JP 2006-69560

(51) Int. Cl. B60T 13/00

(52) U.S. Cl. 303/20

(57) ABSTRACT

A BBW type brake system which operates fluid pressure generators having electric motors as drive sources based on an electrical signal to brake a wheel, field weakening control of the electric motors is performed in the initial stage of operation of the fluid pressure generators to increase the rotational speed of the electric motors. Therefore, it is possible to reduce a time lag before the braking force actually generates after the electrical signal for operating the fluid pressure generators is outputted, thereby improving operational responsiveness. After the braking force actually generates, the field weakening control is cancelled to secure a required braking force with a sufficient torque.

### CROSS-REFERENCE TO RELATED APPLICATIONS

The present invention claims priority under 35 USC 119 based on Japanese patent application No. 2006-069560, filed on Mar. 14, 2006. The entirety of the subject matter of this priority document is incorporated by reference herein.

### BACKGROUND OF THE INVENTION

1. Field of the Invention

The present invention relates to a brake by wire (BBW) type brake system which outputs an electrical signal corresponding to an operation amount of a brake operating element operated by a driver. An actuator, having an electric motor as a drive source, operates based on the electrical signal to brake a wheel.

2. Description of the Related Art

Japanese Patent Application Laid-open No. 2000-127805 discloses a so-called BBW type brake system which operates a fluid pressure brake with brake fluid pressure generated by a power fluid pressure source when communication between a master cylinder that generates brake fluid pressure by a driver depressing a brake pedal and a fluid pressure brake (wheel cylinder) that brakes a wheel is shut off by means of a master cylinder cut valve (stepping force shutoff valve) during normal operation when the power fluid pressure source (fluid pressure generator) that generates brake fluid pressure is operable. The BBW type brake system opens the master cylinder cut valve to operate the fluid pressure brake with the brake fluid pressure generated by the master cylinder and absorbs the brake fluid pressure generated by the master cylinder in the above described normal operation using a stroke simulator. The stroke simulator enables a stroke of the brake pedal during abnormal operation when the power fluid pressure source becomes inoperable.

However, it is known that the unit characteristics of the electric motor used as the drive source of the fluid pressure generator of such a BBW type brake system are determined during the design phase, and that the rated torque becomes low when the rated rotational speed is set to be high, while the rated rotational speed becomes low when the rated torque is set to be high.

When the characteristics of the electric motor for a fluid pressure generator are determined, if the rated torque is set to be high, the reduction ratio of the speed reducer for generating a predetermined braking force can be made small, and therefore a required motor current can be decreased to suppress heat generation. However, since the number of windings of the winding wire is required to be large, there arises a problem of increase in the size of the electric motor. In addition, the rotational speed becomes low, leading to reduced operational responsiveness of the fluid pressure generator.

When the rated torque of the electric motor is set to be low, the number of windings of the winding wire can be made small, and therefore the size of the electric motor can be made small. In addition, the rotational speed becomes high, and therefore the operational responsiveness of the fluid pressure generator can be improved. However, when large torque is to be generated, a large motor current is required, causing a problem of increased heat generation. Then, in order to decrease the motor current, it is conceivable to increase the reduction ratio of the speed reducer, but in this case, there arises a problem that the size of the fluid pressure generator becomes large which makes it more difficult to mount it to a vehicle.

### SUMMARY OF THE INVENTION

The present invention has been achieved in view of the above circumstances, and has an object to improve operational responsiveness by increasing a rotational speed of an electric motor of an actuator of a BBW type brake system as necessary, without increasing the size of the electric motor.

In order to achieve the above object, according to a first feature of the present invention, there is provided a BBW type brake system which outputs an electrical signal corresponding to an operation amount of a brake operating element operated by a driver. The system operates an actuator, having an electric motor as a drive source, to brake a wheel based on the electrical signal, wherein field weakening control of the electric motor is performed in an initial stage of the operation of the actuator.

With this arrangement, in the BBW type brake system which operates the actuator having the electric motor as the drive source based on the electrical signal to brake the wheel, the field weakening control of the electric motor is performed in the initial stage of the operation of the actuator to increase the rotational speed of the electric motor. Therefore, a time lag, which occurs before the braking force is actually generated and after the electrical signal for operating the actuator is outputted, can be reduced, thereby improving the operational responsiveness. After the braking force is actually generated by the operation of the actuator, the field weakening control is cancelled to secure a required braking force with a sufficient torque. With such control it is not required to use an electric motor that is especially large in size, and reduction in the size of the electric motor and improvement of operational responsiveness can be achieved at the same time.

According to a second feature of the present invention, in addition to the first feature, the initial stage of the actuator operation is defined as a time period from start of the operation of the electric motor until contact of brake pads of a disc brake device with a brake disc.

With this arrangement, the field weakening control of the electric motor is performed during the time before the brake pads of the disc brake device are brought into contact with the brake disc and after the electric motor of the actuator starts operation. Therefore, the rotational speed of the electric motor is increased for only the time before the pad clearances between the brake pads and the brake disc are eliminated so as to improve the operational responsiveness. After the pad clearances are eliminated, the field weakening control is cancelled to secure a required braking force with a sufficient torque.

According to a third feature of the present invention, in addition to the first or second feature, the system further comprises a first fluid pressure sensor and a second fluid pressure sensor. The first fluid pressure sensor detects brake fluid pressure between a master cylinder, which is operated by the brake operating element, and a fluid pressure generator, which is operated by the actuator. The second fluid pressure sensor detects brake fluid pressure between the fluid pressure generator and a wheel cylinder. During normal operation, the fluid pressure generator is controlled so that the brake fluid pressure detected by the second fluid pressure sensor changes in accordance with the brake fluid pressure detected by the first fluid pressure sensor.

With this arrangement, during normal operation, the fluid pressure generator is controlled so that the brake fluid pressure between the fluid pressure generator and the wheel cylinder, which is detected by the second fluid pressure sensor, changes in accordance with the brake fluid pressure between the master cylinder and the fluid pressure generator, which is detected by the first fluid pressure sensor. Therefore, the wheel cylinders can be controlled to generate a braking force corresponding to the brake operation of a driver.

According to a fourth feature of the present invention, in addition to the third feature, the master cylinder communicates with a stroke simulator via a reaction force permission valve which opens during normal operation and closes during abnormal operation.

With this arrangement, the master cylinder communicates with the stroke simulator via the reaction force permission valve, which opens during normal operation and closes during abnormal operation. Therefore, during normal operation, the brake fluid pressure generated by the master cylinder is absorbed by the stroke simulator to provide a favorable pedal feeling to the operator. In addition, during abnormal operation, communication with the stroke simulator is shut off to effectively transmit the brake fluid pressure generated by the master cylinder to the wheel cylinder.

According to a fifth feature of the present invention, in addition to the third feature, the system further comprises a stepping force shutoff valve, which closes during normal operation and opens during abnormal operation, between the master cylinder and the fluid pressure generator. A fluid passage between the stepping force shutoff valve and the fluid pressure generator communicates with a reservoir via an atmosphere valve which opens during normal operation and closes during abnormal operation.

With this arrangement, the fluid passage between the stepping force shutoff valve and the master cylinder communicates with the reservoir via the atmosphere valve which opens during the normal operation and closes during the abnormal operation. Therefore, during the normal operation, a shortcoming amount of brake fluid is supplied to the wheel cylinder from the reservoir to prevent occurrence of a drag, and during the abnormal operation, the brake fluid pressure generated by the master cylinder can be prevented from escaping to the reservoir.

A brake pedal 11 of an embodiment corresponds to the brake operating element of the present invention.

The above-mentioned object, other objects, characteristics, and advantages of the present invention will become apparent from a present embodiment, which will be described in detail below by reference to the attached drawings.

### BRIEF DESCRIPTION OF THE DRAWINGS

FIG. 1 is a fluid pressure system diagram during normal operation of a BBW type brake system according to an embodiment of the present invention.

FIG. 2 is a fluid pressure system diagram during abnormal operation corresponding to FIG.

FIG. 3 is a view showing the structure of a disc brake device.

FIG. 4 is a block diagram of the control system of an electric motor.

FIG. 5 is a graph showing the relationship between the piston reaction force and the piston stroke of a wheel cylinder.

FIG. 6 is a diagram showing the map for retrieving a d-axis current command value from the piston stroke of a fluid pressure generator.

### DESCRIPTION OF THE PRESENT EMBODIMENT

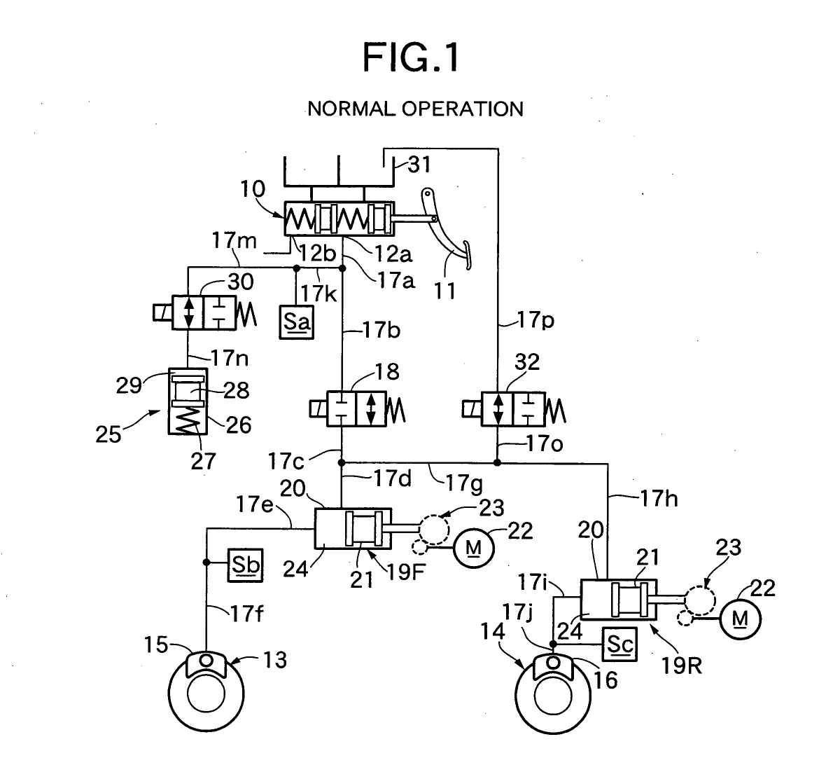

As shown in FIG. 1, a tandem type master cylinder 10 includes first and second output ports 12a and 12b which output brake fluid pressure corresponding to the stepping force with which a driver depresses a brake pedal 11. The first output port 12a is connected to disc brake devices 13 and 14 of a left front wheel and a right rear wheel, for example, and the second output port 12b is connected to disc brake devices at a right front wheel and a left rear wheel, for example. FIG. 1 shows only one brake system which connects to the first output port 12a, and does not show the other brake system which connects to the second output port 12b, but the structures of the one and other brake systems are substantially the same. The one brake system which connects to the first output port 12a will be described below.

The first output port 12a of the master cylinder 10 and a wheel cylinder 15 of the disc brake device 13 of the front wheel are connected with fluid passages 17a to 17f. Fluid passages 17g to 17j which branch from between the fluid passages 17c and 17d are connected to a wheel cylinder 16 of the disc brake device 14 at the rear wheel.

A stepping force shutoff valve 18 which is a normally open type electromagnetic valve is disposed between the fluid passages 17b and 17c. A fluid pressure generator 19F of the front wheel is disposed between the fluid-passages 17d and 17e. The fluid pressure generator 19F includes a cylinder 20 disposed between the fluid passages 17d and 17e. A piston 21, which is slidably fitted in the cylinder 20, is driven by an electric motor 22 via a speed reducing mechanism 23, and can generate brake fluid pressure in a fluid chamber 24 formed on the front surface of the piston 21.

Similarly, a fluid pressure generator 19R of the rear wheel is disposed between the fluid passages 17h and 17i. The fluid pressure generator 19R includes the cylinder 20 disposed between the fluid passages 17h and 17i The piston 21, which is slidably fitted in the cylinder 20, is driven by the electric motor 22 via the speed reducing mechanism 23, and can generate the brake fluid pressure in the fluid chamber 24 formed on the front surface of the piston 21.

A stroke simulator 25 which is connected to a downstream end of fluid passages 17k to 17n which branch from between the fluid passages 17a and 17b is formed by slidably fitting a piston 28 which is biased by a spring 27 in a cylinder 26, so that a fluid chamber 29, which is formed at a side opposite from the spring 27, of the piston 28, communicates with the fluid passage 17n. A reaction force permission valve 30, which is a normally closed type electromagnetic valve, is disposed between the fluid passages 17m and 17n. Fluid passages 17o and 17p which branch from between the fluid passages 17g and 17h communicate with a reservoir 31 of the master cylinder 10. An atmosphere valve 32, which is a normally closed type electromagnetic valve, is disposed between the fluid passages 17o and 17p.

A fluid pressure sensor Sa which detects the brake fluid pressure generated by the master cylinder 10, a fluid pressure sensor Sb which detects the brake fluid pressure transmitted to the disc brake device 13 of the front wheel, and a fluid pressure sensor Sc which detects the brake fluid pressure transmitted to the disc brake device 14 of the rear wheel are connected to an electronic control unit (not shown) which controls the stepping force shutoff valve 18, the reaction force permission valve 30, the atmosphere valve 32 and the electric motors 22 and 22 of the fluid pressure generators 19F and 19R.

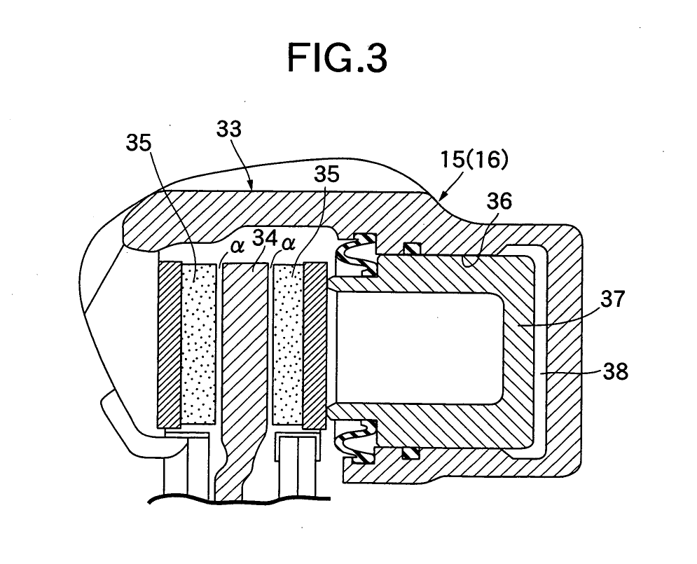

As shown in FIG. 3, the wheel cylinders 15 and 16 of the disc brake device 13 of the front wheel and the disc brake device 14 of the rear wheel each include: a brake caliper 33 which is floatingly supported at a vehicle body to be laterally movable; a pair of brake pads 35 and 35 which are supported at the brake caliper 33 movably close to and away from each other to sandwich a brake disc 34 which rotates with the wheel; a piston 37 which is slidably fitted in a cylinder hole 36 formed in the brake caliper 33; and a fluid chamber 38 formed at the rear of the piston 37. When the wheel cylinders 15 and 16 are not operated, pad clearances a exist between the brake disc 34, and the brake pads 35 and 35.

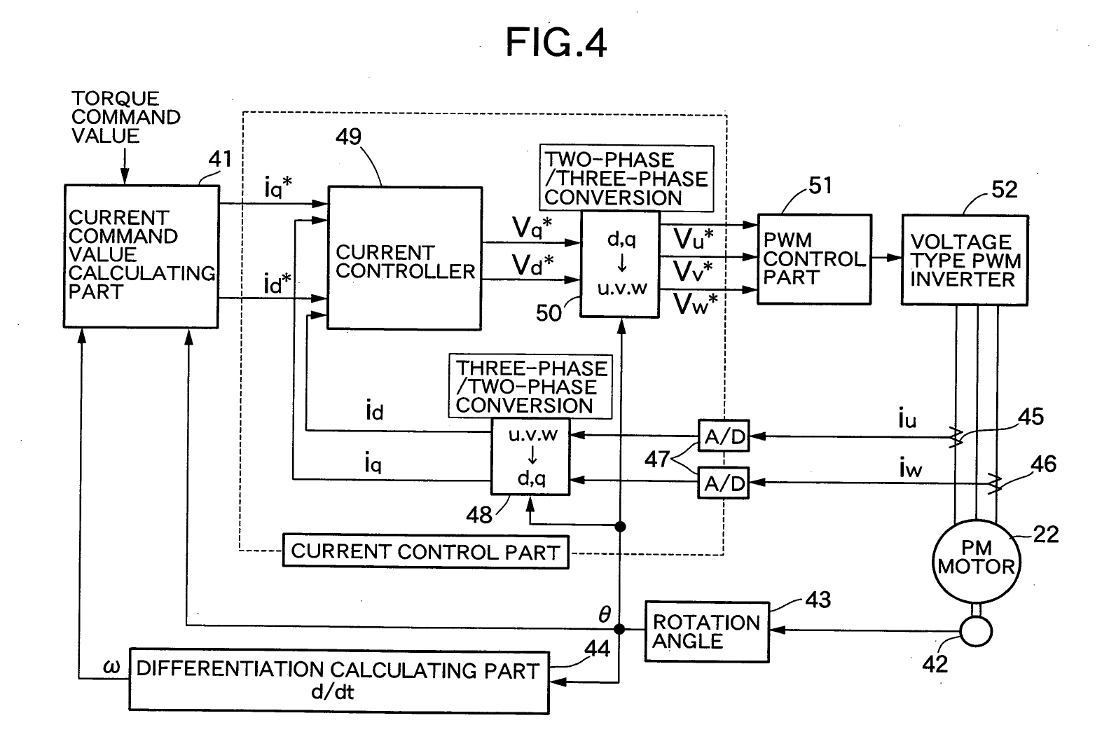

As shown in FIG. 4, an electric motor control part of the electronic control unit, which controls the operation of the electric motor 22 comprising a permanent magnet synchronous motor (a brushless DC motor or an AC servo motor), includes a current command value calculating part 41, a resolver 42, a rotation angle calculating part 43, a differentiator 44, a u-phase current sensor 45, a w-phase current sensor 46, an A/D converter 47, a three-phase/two-phase converter 48, a current controller 49, a two-phase/three-phase converter 50, a PWM control part 51 and an inverter 52.

Next, the embodiment of the present invention including the above described construction will be described.

During normal operation shown in FIG. 1, the solenoids of the stepping force shutoff valve 18, the reaction force permission valve 30 and the atmosphere valve 32 are excited by commands from the electronic control unit; the stepping force shutoff valve 18 is closed to shut off communication between the master cylinder 10 and the disc brake devices 13 and 14; the reaction force permission valve 30 is opened to provide communication between the master cylinder 10 and the stroke simulator 25; and the atmosphere valve 32 is opened. When the driver depresses the brake pedal 11 in this state and the master cylinder 10 generates brake fluid pressure, the fluid pressure sensor Sa detects the brake fluid pressure of the fluid passage 17k closed by the stepping force shutoff valve 18. The electronic control unit operates the fluid pressure generators 19F and 19R of the front wheel and the rear wheel, thereby causing the fluid passages 17f and 17j to generate fluid pressure corresponding to the brake fluid pressure detected by the fluid pressure sensor Sa.

As a result, the drive force of the electric motor 22 of the fluid pressure generator 19F of the front wheel is transmitted to the piston 21 via the speed reducing mechanism 23, and the brake fluid pressure generated in the fluid chamber 24 of the cylinder 20 is transmitted to the wheel cylinder 15 of the disc brake device 13 through the fluid passages 17e and 17f, thereby braking the front wheel. At this time, the brake fluid pressure of the fluid passage 17f is detected by the fluid pressure sensor Sb, and the operation of the electric motor 22 is feedback-controlled so that the brake fluid pressure has the value corresponding to the brake fluid pressure detected by the fluid pressure sensor Sa of the fluid passage 17k.

Similarly, the drive force of the electric motor 22 of the fluid pressure generator 19R of the rear wheel is transmitted to the piston 21 via the speed reducing mechanism 23, and the brake fluid pressure generated in the fluid chamber 24 of the cylinder 20 is transmitted to the wheel cylinder 16 of the disc brake device 14 through the fluid passages 17i and 17j, thereby braking the rear wheel. At this time, the brake fluid pressure of the fluid passage 17j is detected by the fluid pressure sensor Sc, and the operation of the electric motor 22 is feedback-controlled so that the brake fluid pressure has the value corresponding to the brake fluid pressure detected by the fluid pressure sensor Sa of the fluid passage 17k.

When the piston 21 in the cylinder 20 slightly advances by the electric motor 22, communication between the fluid chamber 24 and the fluid passage 17d (or the fluid passage 17h) is shut off, and therefore there is no fear that brake fluid pressure generated by the cylinder 20 escapes to the reservoir 31 via the atmosphere valve 32 provided between the fluid passages 17o and 17p.

During the above described normal operation, the stepping force shutoff valve 18 is kept in the closed state unless an abnormal state such as a failure of the power supply occurs. Therefore, in the conventional brake system, there is a possibility of a problem that if the brake pads of the disc brake devices 13 and 14 wear, and the volume of the fluid passages 17e and 17f or the volume of the fluid passages 17i and 17j between the cylinders 20 and 20 and the disc brake device 13 and 14 increase, the brake fluid corresponding to this amount cannot be supplied from the reservoir 31 and the drag of the wheel cylinders 15 and 16 cannot be reduced.

However, when the pistons 21 and 21 retreat in the cylinders 20 and 20, the fluid chambers 24 and 24 communicate with the reservoir 31 via the opened atmosphere valve 32. Therefore, the brake fluid, which becomes insufficient due to wear of the brake pads of the disc brake devices 13 and 14, can be replenished from the reservoir 31, and the drag of the wheel cylinders 15 and 16 at the time of release of the braking force can be reduced.

When the driver depresses the brake pedal 11, and the master cylinder 10 generates the brake fluid pressure during normal operation, the brake fluid pressure is transmitted to the fluid chamber 29 of the stroke simulator 25, and the piston 28 moves against the elastic force of the spring 27, thereby generating the reaction force to depression of the brake pedal 11. Therefore, though the disc brake devices 13 and 14 are actually operated by the drive force of the electric motors 22 and 22, the driver can obtain operation feeling which is equivalent to that obtained when operating the disc brake devices 13 and 14 by the stepping force of the driver.

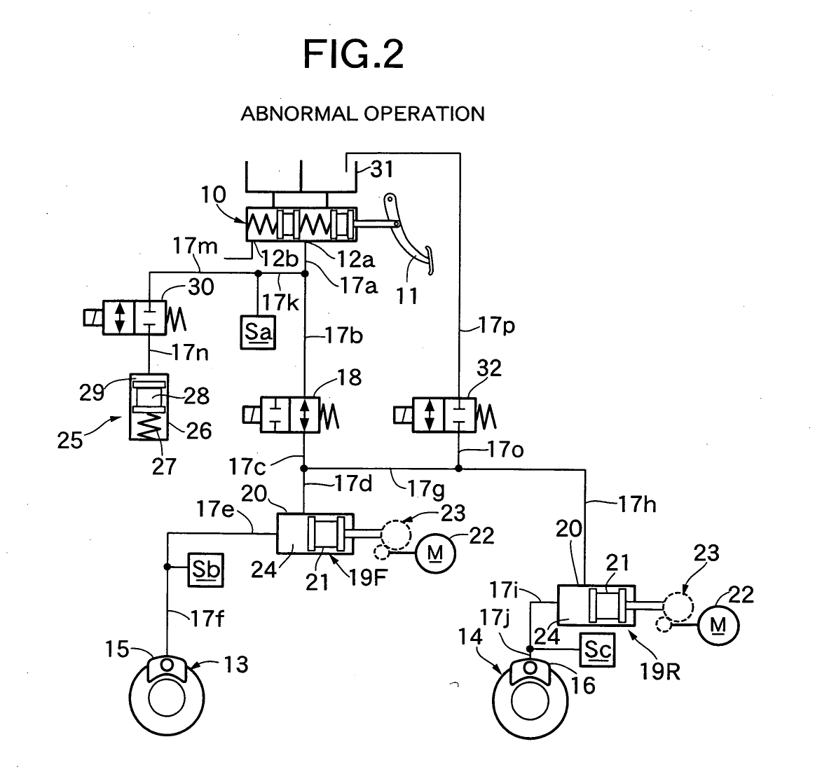

On the other hand, during abnormal operation such as a power failure due to removal of the battery or the like, the stepping force shutoff valve 18 opens to provide communication between the master cylinder 10 and the disc brake devices 13 and 14 as shown in FIG. 2; the reaction force permission valve 30 closes to shut off communication between the master cylinder 10 and the stroke simulator 25; and the atmosphere valve 32 closes to shut off communication between the master cylinder 10 and the reservoir 31. As a result, the brake fluid pressure which is generated in the master cylinder 10 by the driver depressing the brake pedal 11 is transmitted to the wheel cylinder 15 of the disc brake device 13 of the front wheel via the opened stepping force shutoff valve 18 and the fluid pressure generator 19F; and is transmitted to the wheel cylinder 16 of the disc brake device 14 of the rear wheel via the opened stepping force shutoff valve 18 and the fluid pressure generator 19k to brake the front wheel and the rear wheel.

At the same time, communication between the stroke simulator 25 and the master cylinder 10 is shut off by closing the reaction force permission valve 30, and therefore the stroke simulator 25 stops its function. As a result, the stroke of the brake pedal 11 can be prevented from unnecessarily increasing to give an uncomfortable feeling to the driver. In addition, the brake fluid pressure generated by the master cylinder 10 is transmitted to the wheel cylinders 15 and 16 without being absorbed by the stroke simulator 25, thereby generating a braking force with a high responsiveness.

Thus, even if the power supply fails and the stepping force shutoff valve 18, the reaction force permission valve 30, the atmosphere valve 32 and the fluid pressure generators 19F and 19R become inoperable, the wheel cylinders 15 and 16 of the front wheel and the rear wheel can be operated without any problem with the brake fluid pressure generated in the master cylinder 10 by the driver depressing the brake pedal 11, thereby braking the front wheel and the rear wheel to more safely stop the vehicle during abnormal operation.

Next, a general control method of the electric motors 22 of the fluid pressure generators 19F and 19R will be described based on FIG. 4.

Based on the output of the three fluid pressure sensors Sa, Sb and Sc (see FIG. 1) provided in the fluid pressure circuit, a torque command value of the electric motor 22 is inputted into the current command value calculating part 41. The current command value calculating part 41 calculates a current command value Iq* of a q-axis component of the electric motor 22, and a current command value Id* of a d-axis component. In this process, the current command value Iq* of the q-axis component is outputted to be proportional to the torque command value, while the current command value Id* of the d-axis component is basically set at zero except for in the initial stage of the operation of the electric motor 22 as described in detail below.

The rotation angle calculating part 43, which is connected to the resolver 42 provided at the electric motor 22, calculates a rotation angle θ of the electric motor 22. The differentiator 44 performs time differentiation of the rotation angle θ to calculate the rotation angular velocity ω of the electric motor 22. The rotation angle θ and rotation angular velocity ω are inputted into the current command value calculating part 41, and used for calculation of the current command value Iq* of the q-axis component.

The electric motor 22 is feedback-controlled while detecting actual motor currents Iu, Iv and Iw (only Iu and Iw are used in this embodiment) with respect to the current command value Iq* of the q-axis component and the current command value Id* of the d-axis component. Namely, a u-phase current Iu and a w-phase current Iw of the electric motor 22 which are detected by the u-phase current sensor 45 and the w-phase current sensor 46 are converted into digital values from analog values with the A/D converter 47, and then inputted into the three-phase/two-phase converter 48 for vector control, where they are converted into an actual current Iq of the q-axis component and an actual current Id of the d-axis component by using the rotation angle θ of the electric motor 22. The current controller 49 performs calculation by proportional/integral control so as to converge a deviation between the current command value Iq* and the actual current Iq of the q-axis component and a deviation between the current command value Id* and the actual current Id of the d-axis component to zero, and outputs a voltage command value Vq* of the q-axis component and a voltage command value Vd* of the d-axis component.

A three-phase current is required to be supplied to the electric motor 22, and thus in the two-phase/three-phase converter 50, the voltage command value Vq* of the q-axis component and the voltage command value Vd* of the d-axis component are converted into a u-phase voltage voltage command value Vu*, a u-phase voltage voltage command value Vv* and a u-phase voltage voltage command value Vw*. The PWM control part 51 outputs a PWM control signal based on the u-phase, v-phase and w-phase voltage voltage command values Vu*, Vv* and Vw*. The inverter 52 supplies the u-phase, v-phase and w-phase currents Iu, Iv and Iw to the electric motor 22 so that the deviation between the current command value Iq* and the actual current Iq of the q-axis component, and the deviation between the current command value Id* and the actual current Id of the d-axis component converge to zero.

The general vector control of the electric motor 22 has been described above. Control of the electric motor 22 at the time of starting the operation of the fluid pressure generators 19F and 19R will be described below.

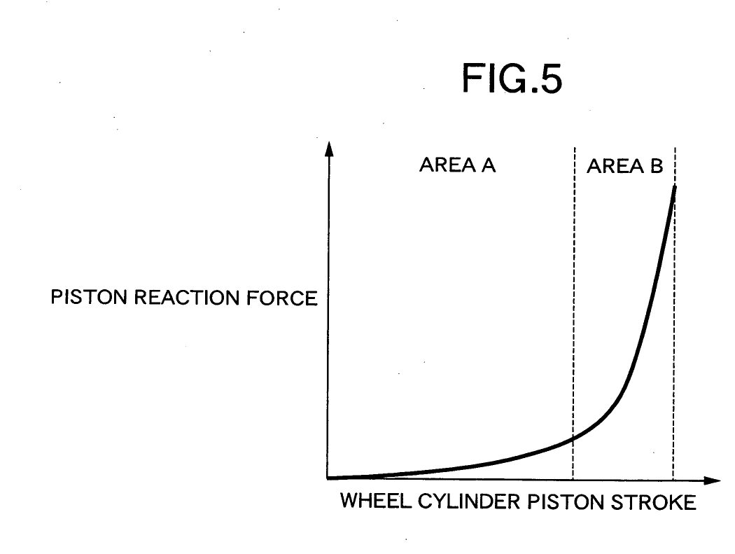

As shown in FIG. 5, when the driver depresses the brake pedal 11 to operate the fluid pressure generators 19F and 19R, and the disc brake devices 13 and 14 are operated with brake fluid pressure generated by the fluid pressure generators 19F and 19R, control of the electric motor 22 differs between an area A before the brake pads 35 and 35 are brought into contact with the brake disc 34, and an area B after the brake pads 35 and 35 are brought into contact with the brake disc 34. Namely, the areas A and B are determined in accordance with the pad clearances a (see FIG. 3): the area A is the area in which a reaction force hardly increases since the pad clearances a exist even though the strokes of the pistons 37 of the wheel cylinders 15 and 16 increase; and the area B is the area in which the reaction force abruptly increases if the strokes of the pistons 37 increase since the pad clearances a have already been eliminated.

The wheel cylinders 15 and 16 and the fluid pressure generators 19F and 19R are connected by the fluid passages 17e and 17f, and the fluid passages 17i and 17j, respectively. Therefore, the strokes of the pistons 37 of the wheel cylinders 15 and 16 are proportional to the strokes of the pistons 21 of the fluid pressure generators 19F and 19R. Therefore, the operation of the electric motors 22 is controlled in accordance with the strokes of the pistons 21 of the fluid pressure generators 19F and 19R.

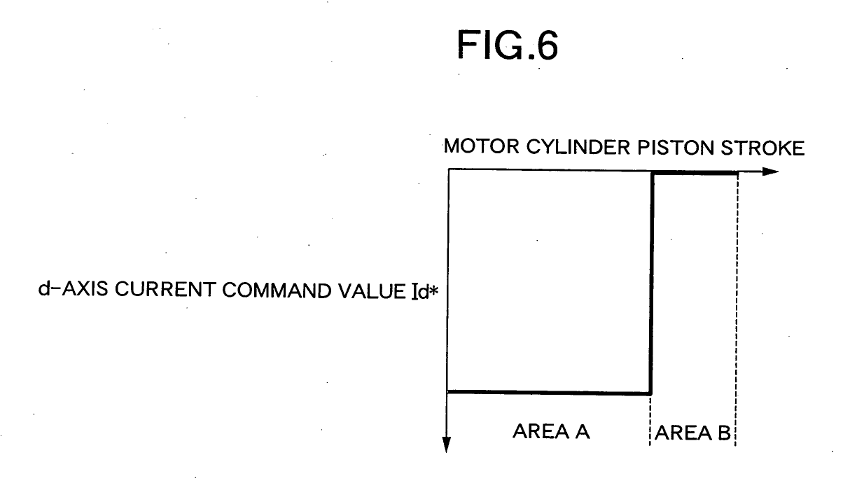

As shown in the map of FIG. 6, in the area A in which there are the pad clearances α of the wheel cylinders 15 and 16, the rotational speed of the electric motors 22 is increased by greatly increasing the current command value Id* in the d-axis direction of the electric motors 22 toward the negative direction, that is, by performing the so-called field weakening control, and in the area B in which there are no pad clearances a of the pistons 37 of the wheel cylinders 15 and 16, torque of the current motors 22 is increased by making the current command value Id* in the d-axis direction of the electric motors 22 zero or substantially zero. More specifically, the current command value Id* in the d-axis direction, which is retrieved from the map in FIG. 6, is inputted into the current controller 49 in the block diagram in FIG. 4, thereby achieving the above described field weakening control of the electric motor 22 in the initial stage of the operation.

As described above, the field weakening control of the electric motors 22 is performed to increase the rotational speed of the electric motors 22 only for the time before the brake pads 35 and 35 of the wheel cylinders 15 and 16 are brought into contact with the brake discs 34 after the fluid pressure generators 19F and 19R start operation. Therefore, a time lag before the braking force actually generates after the electrical signals for operating the fluid pressure generators 19F and 19R are outputted is decreased to improve operational responsiveness, and thereafter the field weakening control is cancelled to secure a required braking force with a sufficient torque. Therefore, the electric motor 22 which is especially large in size does not have to be used, and reduction in the size of the electric motor 22 and improvement in operational responsiveness can be achieved at the same time.

The embodiment of the present invention has been described above, but various changes in design can be made without departing from the subject matter of the present invention.

For example, the actuator of the present invention is not limited to the one that generates brake fluid pressure with the drive forces of the electric motors 22 to operate the wheel cylinders 15 and 16, but may be the one that directly operates the brake pads 35 and 35 with the electric motors 22 without using the brake fluid pressure.

What is claimed is:

1. A BBW type brake system which outputs an electrical signal corresponding to an operational amount of a brake operating element operated by a driver, and operates an actuator having an electric motor as a drive source based on the electrical signal to brake a wheel,
wherein field weakening control of the electric motor is performed in an initial stage of operation of the actuator.

2. The BBW type brake system according to claim 1, wherein the initial stage of the operation is a time period from start of operation of the electric motor until contact of brake pads of a disc brake device with a brake disc.

3. The BBW type brake system according to claim 1, wherein the field weakening control is cancelled when braking force is actually generated by the brake system after the initial stage of operation of the actuator.

4. The BBW type brake system according to claim 1, further comprising a first fluid pressure sensor which detects brake fluid pressure between a master cylinder which is operated by the brake operating element and a fluid pressure generator which is operated by the actuator, and a second fluid pressure sensor which detects brake fluid pressure between the fluid pressure generator and a wheel cylinder; wherein during normal operation, the fluid pressure generator is controlled so that the brake fluid pressure detected by the second fluid pressure sensor changes in accordance with the brake fluid pressure detected by the first fluid pressure sensor.

5. The BBW type brake system according to claim 3, wherein the master cylinder communicates with a stroke simulator via a reaction force permission valve which opens during normal operation and closes during abnormal operation.

6. The BBW type brake system according to claim 3, further comprising a stepping force shutoff valve, which closes during normal operation and opens during abnormal operation, between the master cylinder and the fluid pressure generator; wherein a fluid passage between the stepping force shutoff valve and the fluid pressure generator communicates with a reservoir via an atmosphere valve which opens during normal operation and closes during abnormal operation.

7. The BBW type brake system according to claim 2, further comprising a first fluid pressure sensor which detects brake fluid pressure between a master cylinder which is operated by the brake operating element and a fluid pressure generator which is operated by the actuator, and a second fluid pressure sensor which detects brake fluid pressure between the fluid pressure generator and a wheel cylinder; wherein during normal operation, the fluid pressure generator is controlled so that the brake fluid pressure detected by the second fluid pressure sensor changes in accordance with the brake fluid pressure detected by the first fluid pressure sensor.

8. The BBW type brake system according to claim 7, wherein the master cylinder communicates with a stroke simulator via a reaction force permission valve which opens during normal operation and closes during abnormal operation.

9. The BBW type brake system according to claim 7, further comprising a stepping force shutoff valve, which closes during normal operation and opens during abnormal operation, between the master cylinder and the fluid pressure generator; wherein a fluid passage between the stepping force shutoff valve and the fluid pressure generator communicates with a reservoir via a atmosphere valve which opens during normal operation and closes during abnormal operation.

10. A BBW type brake system for a vehicle comprising:
a brake operating element to be operated by a driver;
a sensor which senses an operational amount of the brake operating element and outputs an electrical signal based thereon;
a actuator which brakes a wheel of the vehicle, the actuator including an electric motor; and
a controller which controls operation of the actuator based on the electrical signal output by the sensor;
wherein the controller performs field weakening control of the electric motor in an initial stage of operation of the actuator.

11. The BBW type brake system according to claim 10, further comprising a disc brake device including brake pads and a brake disc, and the initial stage of the operation is a time period from start of operation of the electric motor until contact of the brake pads with the brake disc.

12. The BBW type brake system according to claim 10, wherein the controller cancels the field weakening control when braking force is actually generated by the brake system after the initial stage of operation of the actuator.

13. The BBW type brake system according to claim 10, further comprising a master cylinder which is operated by the brake operating element, a fluid pressure generator which is operated by the actuator, a wheel cylinder, a first fluid pressure sensor which detects brake fluid pressure between the master cylinder and the fluid pressure generator, and a second fluid pressure sensor which detects brake fluid pressure between the fluid pressure generator and the wheel cylinder; wherein during normal operation, the fluid pressure generator is controlled so that the brake fluid pressure detected by the second fluid pressure sensor changes in accordance with the brake fluid pressure detected by the first fluid pressure sensor.

14. The BBW type brake system according to claim 13, further comprising a stroke simulator and a reaction force permission valve which opens during normal operation and closes during abnormal operation, and the master cylinder communicates with the stroke simulator via the reaction force permission valve.

15. The BBW type brake system according to claim 13, further comprising a stepping force shutoff valve which closes during normal operation and opens during abnormal operation, a fluid reservoir, and an atmosphere valve which opens during normal operation and closes during abnormal operation, the stepping force shutoff valve is disposed between the master cylinder and the fluid pressure generator; and a fluid passage between the stepping force shutoff valve and the fluid pressure generator communicates with the reservoir via the atmosphere valve.

16. A method of controlling a BBW type brake system for a vehicle which outputs an electrical signal corresponding to an operational amount of a brake operating element operated by a driver, and operates an actuator having an electric motor as a drive source based on the electrical signal to brake a wheel of the vehicle, the method comprising the steps of:
performing field weakening control of the electric motor in an initial stage of operation of the actuator; and
canceling the field weakening control when braking force is actually generated by the brake system after the initial stage of operation of the actuator.

17. The method according to claim 16, wherein the initial stage of the operation is a time period from start of operation of the electric motor until contact of brake pads of a disc brake device with a brake disc.

18. The method according to claim 16, wherein in the brake system a first fluid pressure sensor detects brake fluid pressure between a master cylinder which is operated by the brake operating element and a fluid pressure generator which is operated by the actuator, and a second fluid pressure sensor detects brake fluid pressure between the fluid pressure generator and a wheel cylinder, and the method further comprises the step of controlling the fluid pressure generator during normal operation so that the brake fluid pressure detected by the second fluid pressure sensor changes in accordance with the brake fluid pressure detected by the first fluid pressure sensor.

19. The method according to claim 18, wherein in the brake system the master cylinder communicates with a stroke simulator via a reaction force permission valve, and the method further comprises the steps of opening the reaction force permission valve during normal operation and closing the reaction force permission valve during abnormal operation.

20. The method according to claim 18, wherein in the brake system a stepping force shutoff valve is disposed between the master cylinder and the fluid pressure generator, and a fluid passage extends between the stepping force shutoff valve and the fluid pressure generator and communicates with a fluid reservoir via an atmosphere valve, and the method further comprising the steps of:
controlling the stepping force shutoff valve to close during normal operation and open during abnormal operation; and
controlling the atmosphere valve to open during normal operation and close during abnormal operation.
